(19) United States
(12) Patent Application Publication
(10) Pub. No.: US 2012/0226484 A1
(43) Pub. Date: Sep. 6, 2012

(54) CALCULATION SIMULATION SYSTEM AND METHOD THEREOF

(75) Inventors: Duk Yun Nam, Daejeon (KR); Jong Bae Moon, Daejeon (KR); Kum Won Cho, Daejeon (KR)

(73) Assignee: KOREA INSTITUTE OF SCIENCE & TECHNOLOGY INFORMATION, Daejeon (KR)

(21) Appl. No.: 13/501,444

(22) PCT Filed: Oct. 5, 2010
(86) PCT No.: PCT/KR10/06771

§ 371 Date: Apr. 11, 2012

(30) Foreign Application Priority Data
Nov. 24, 2009 (KR) 10-2009-0113989

(51) Int. Cl. G06G 7/48; G06F 7/60

(52) U.S. Cl. 703/2

(57) ABSTRACT

A calculation simulation system which performs a calculation simulation using computing resources includes: a simulation condition setting unit that sets simulation conditions based on input from a user; a calculation simulation performing unit that performs the calculation simulation; a simulation result storage unit that stores already-performed simulation conditions, simulation results, and performance records; and a simulation function performing unit that provides the already-performed simulation results, if the simulation conditions input by the user are the same as the already-performed simulation conditions. Further, the calculation simulation performing unit performs calculation simulation using the computing resources under the simulation conditions input by the user, if the simulation conditions input by the user are different from the already-performed simulation conditions.

### TECHNICAL FIELD

The present invention relates to a calculation simulation system and a method thereof.

### BACKGROUND ART

At present, in research utilizing a calculation simulation, a researcher performs a simulation on computing resources by determining a simulation model, parameters, and input data and analyzes the results to identify a new phenomenon. At this time, a plurality of simulation works including various parameters and input data are requested on the computing resources and, if a plurality of simulation results are analyzed together, a meaningful analysis may be obtained.

Here, the simulation is a calculating analysis method and requires more than a certain amount of time. Thus, it takes a lot of time to obtain a plurality of simulation results due to limitations of computing resources, which is problematic.

Moreover, as the time for utilizing the computing resource increases, a user will have to pay much more expenses.

However, the amount of computing resources is increased or the simulation codes are optimized to reduce the time, but there are limitations in terms of economic aspects such as purchasing costs, operating costs, etc. to increase the amount of computing resources and in terms of technical aspects for optimizing the simulation codes.

### DISCLOSURE

### Technical Problem

Accordingly, the present invention has been made to solve the above-described problems, and an object of the present invention is to provide a calculation simulation system using computing resources and a method thereof, which can reduce the time required for the simulation and the time required for the computation.

### Technical Solution

According to one aspect of the present invention, there is provided a calculation simulation system which performs a calculation simulation using computing resources, the calculation simulation system comprising: a simulation condition setting unit for setting simulation conditions based on input from a user; a calculation simulation performing unit for performing the calculation simulation; a simulation result storage unit for storing already-performed simulation conditions, simulation results, and performance records; and a simulation function performing unit for providing the already-performed simulation conditions, if the simulation conditions input by the user are the same as the already-performed simulation conditions.

Here, the calculating simulation performing unit may perform the calculation simulation using the computing resources under the simulation conditions input by the user, if the simulation conditions input by the user are different from the already-performed simulation conditions.

The simulation result storage units may store the results of the calculation simulation performed by the calculation simulation performing unit under the simulation conditions input by the user.

The simulation conditions may comprise parameters, simulation models, and simulation program-related information, and the performance records may comprise simulation performance date and time, simulation run time, simulation resources used, and location of simulation result data.

The simulation result storage unit may store the simulation conditions, and the simulation function performing unit may comprise: a performance record extracting means for extracting the performance records of the already-performed simulation stored in the simulation result storage unit; a simulation condition comparing means for comparing whether the simulation conditions input by the user are the same as the simulation conditions included in the performance records; and a simulation result extracting means for providing the simulation results stored in the simulation result storage unit, if the simulation conditions input by the user are the same as the simulation conditions extracted.

The calculation simulation performing unit may extract the simulation conditions from the simulation result storage unit, and the calculation simulation performing unit may generate a work specification including the simulation conditions and a simulation performance program.

The calculation simulation performing unit may store the results of the simulation performed on the computing resources in the simulation result storage unit.

The calculation simulation performing unit may store the simulation conditions, the simulation results, and the performance records in the simulation result storage unit.

The calculation simulation system may further comprise a computing resource setting unit for setting the computing resources on which the simulation is performed, a simulation monitoring unit for monitoring the state of the simulation performed on the computing resources, and a certificate management unit for managing a certificate required for authentication for use of the computing resources.

According to another aspect of the present invention, there is provided a calculation simulation method which performs a calculation simulation using computing resources, the calculation simulation method comprising: setting simulation conditions based on input from a user; retrieving already-performed simulation conditions which are the same as the simulation conditions; and providing the already-performed simulation conditions if there are the already-performed simulation conditions which are the same as the simulation conditions.

Here, the providing of the simulation conditions may comprise: retrieving and extracting the storage location of simulation result data; and providing the simulation results.

If there are no already-performed simulation conditions which are the same as the simulation conditions, the retrieving may comprise, between the retrieving and the providing of the simulation results, generating the simulation results based on the input from the user by performing the calculation simulation under the simulation conditions using the computing resources, and providing the simulation results.

The calculation simulation method may further comprise, after providing the simulation results, storing the simulation results, and the storing of the simulation results may further comprise storing the simulation conditions input by the user and the storage location of the simulation result data.

The calculation simulation method may further comprise, before setting the simulation conditions, authenticating the use of the computing resources.

### Advantageous Effects

According to the exemplary embodiments of the present invention, it is possible to display the results of the already-performed simulation to the user under the same simulation conditions without performing a new simulation on the computing resources, and thus it is possible to reduce the time required for the simulation and the time required for the use of the computing resources.

Moreover, it is possible to reduce the time required for the simulation without incurring costs for adding computing resources or further utilizing the computing resources.

Furthermore, it is possible to impart reliability to the result data through history management on the simulation results by storing the simulation results together with the simulation conditions, simulation performance date and time, and performer.

### DESCRIPTION OF DRAWINGS

FIG. 1 is diagram showing the connection relationship between a calculation simulation system, a computing resource, and a communication network.

FIG. 2 is a diagram showing the configuration of a calculation simulation system in accordance with an exemplary embodiment of the present invention.

FIG. 3 is a diagram showing the configuration of a simulation condition setting unit of the calculation simulation system in accordance with the exemplary embodiment of the present invention.

FIG. 4 is a diagram showing the configuration of a computing resource setting unit of the calculation simulation system in accordance with the exemplary embodiment of the present invention.

FIG. 5 is a diagram showing the configuration of a calculation simulation performing unit of the calculation simulation system in accordance with the exemplary embodiment of the present invention.

FIG. 6 is a diagram showing the configuration of a simulation function performing unit of the calculation simulation system in accordance with the exemplary embodiment of the present invention.

FIG. 7 is a diagram showing the configuration of a calculation simulation monitoring unit of the calculation simulation system in accordance with the exemplary embodiment of the present invention.

FIG. 8 is a diagram showing the configuration of a simulation result storage unit of the calculation simulation system in accordance with the exemplary embodiment of the present invention.

FIG. 9 is a diagram showing the configuration of a certificate management unit of the calculation simulation system in accordance with the exemplary embodiment of the present invention.

FIG. 10 is a flowchart showing a calculation simulation method in accordance with another exemplary embodiment of the present invention performed by the calculation simulation system of the present invention.

### MODE FOR INVENTION

The features and advantages of the present invention will be more clearly understood from the following detailed description taken in conjunction with the accompanying drawings.

Hereinafter, a calculation simulation system and a method thereof in accordance with exemplary embodiments of the present invention will be described in detail with reference to the accompanying drawings. Throughout the accompanying drawings, the same reference numerals are used to designate the same or similar components, and redundant descriptions thereof are omitted.

FIG. 1 is diagram showing the connection relationship between a calculation simulation system, a computing resource, and a communication network. As shown in FIG. 1, the calculation simulation system may be connected to a user terminal and computing resources through a communication network.

A user may access and use the calculation simulation system using the user terminal, and the calculation simulation system may perform a calculation simulation using the computing resources.

The calculation simulation system disclosed in the present embodiment aims at analyzing a real or virtual phenomenon by obtaining simulation results through numerical calculation by adjusting various variables by modeling the real or virtual phenomenon. The simulation requires a lot of time, and thus a plurality of computing resources are used to reduce the time required to obtain the simulation results.

During the simulation performed by the calculation simulation system, if the algorithm of the simulation obtains the same results using a deterministic algorithm, i.e., the same parameters, models, and input data, the calculation simulation system does not perform a new simulation work on the computing resources but displays the results of the already-performed simulation to the user, thus allowing the user to obtain the results of the simulation without performing the actual simulation.

When simulation conditions are input from the user terminal, the calculation simulation system of the present embodiment performs the simulation on the computing resources or extracts the results of the already-performed simulation from the simulation system and displays the results.

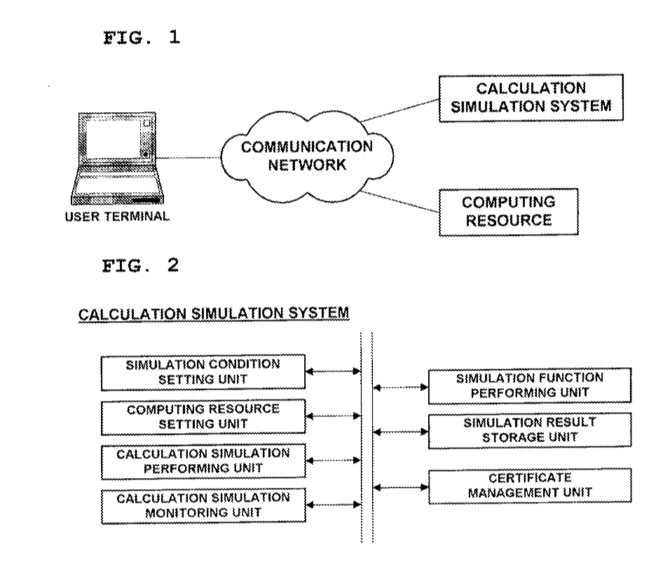

FIG. 2 is a diagram showing the configuration of the calculation simulation system in accordance with an exemplary embodiment of the present invention. As shown in FIG. 2, the calculation simulation system comprises a simulation condition setting unit, a computing resource setting unit, a calculation simulation performing unit, a calculation simulation monitoring unit, a simulation function performing unit, a simulation result storage unit, and a certificate management unit.

The simulation condition setting unit is a component for setting parameter information, a model, and a simulation performance program which are input for performing the simulation.

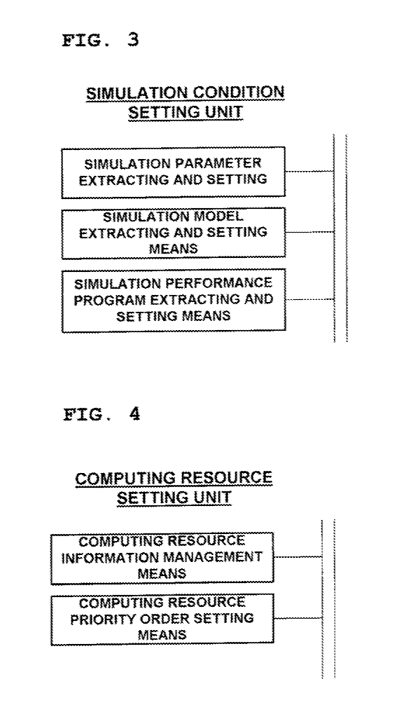

FIG. 3 is a diagram showing the configuration of the simulation condition setting unit of the calculation simulation system in accordance with the exemplary embodiment of the present invention. As shown in FIG. 3, the simulation condition setting unit comprises a simulation parameter extracting and setting means, a simulation model extracting and setting means, and a simulation performance program extracting and setting means.

Here, the simulation conditions may include information on the parameters, the simulation model, and the simulation program.

In more detail, the simulation parameter extracting and setting means extracts parameter information, which the user will utilize in the user terminal, from the simulation result storage unit and sets the parameter information.

The simulation model extracting and setting means extracts a simulation model, which will be used in the simulation, and sets the simulation model.

The simulation performance program extracting and setting means extracts a performance program, which performs the simulation, from the simulation result storage unit and sets the performance program.

Information set by the above means is stored in the simulation result storage unit.

The computing resource setting unit is a component for setting the computing resources on which the simulation will be performed.

FIG. 4 is a diagram showing the configuration of the computing resource setting unit of the calculation simulation system in accordance with the exemplary embodiment of the present invention. As shown in FIG. 4, the computing resource setting unit comprises a computing resource information management means and a computing resource priority order setting means.

In more detail, the computing resource information management means manages information of the computing resources used in the simulation.

The computing resource priority order setting means sets the priority order of the computing resources that will submit a simulation work.

The calculation simulation performing unit is a component for generating and transmitting the work specification for the submission of the simulation work and storing the simulation results.

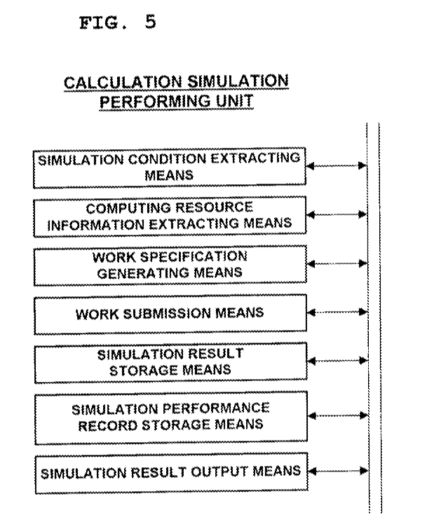

FIG. 5 is a diagram showing the configuration of the calculation simulation performing unit of the calculation simulation system in accordance with the exemplary embodiment of the present invention. As shown in FIG. 5, the calculation simulation performing unit comprises a simulation condition extracting means, a computing resource information extracting means, a work specification generating means, a work submission means, a simulation result storage means, a simulation performance record storage means, and a simulation result output means.

In more detail, the simulation condition extracting means extracts the simulation conditions from the information stored in the simulation result storage unit by the simulation condition setting unit.

The computing resource information extracting means extracts the information stored in the computing resource setting unit, and this information will be utilized by the work submission means.

The work specification generating means generates a work specification including a document, which specifies the simulation performance program, and the simulation conditions.

The work submission means transmits the work specification generated by the work specification generating means to the computing resources based on the priority order of the computing resources extracted by the computing resource priority order setting means.

The simulation result storage means receives result data of the simulation performed on the computing resources and stores the result data in the simulation result storage unit.

The simulation performance record storage means stores simulation-related records utilized by the work submission means in the simulation result storage unit. Here, the simulation-related records may include simulation performance records, and the performance records may include the simulation conditions, simulation performance date and time, simulation run time, simulation resources used, and simulation result data location.

The simulation result output means outputs the result data of the simulation performed on the computing resources.

The simulation function performing unit is a component for retrieving and displaying the results of the already-performed simulation with respect to a request to perform the simulation under the same conditions.

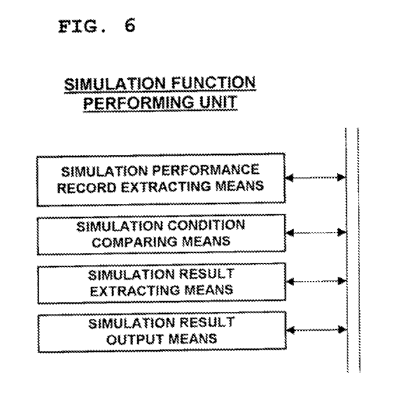

FIG. 6 is a diagram showing the configuration of the simulation function performing unit of the calculation simulation system in accordance with the exemplary embodiment of the present invention. As shown in FIG. 6, the simulation function performing unit comprises a simulation performance record extracting means, a simulation condition comparing means, a simulation result extracting means, and a simulation result output means.

In more detail, the simulation performance record extracting means extracts a performance record already stored in the simulation result storage unit.

The simulation condition comparing means compares whether there are already-performed simulation conditions, which are the same as the simulation conditions currently input by the user, and informs the results.

If the simulation condition comparing means determines that the simulation conditions input by the user are the same as the already-performed simulation conditions, the simulation result extracting means extracts the already-performed simulation conditions from the simulation result storage unit.

The simulation result output means outputs simulation output data extracted by the simulation result extracting means.

The calculation simulation monitoring unit is a component for monitoring the state of the simulation performed on the computing resources.

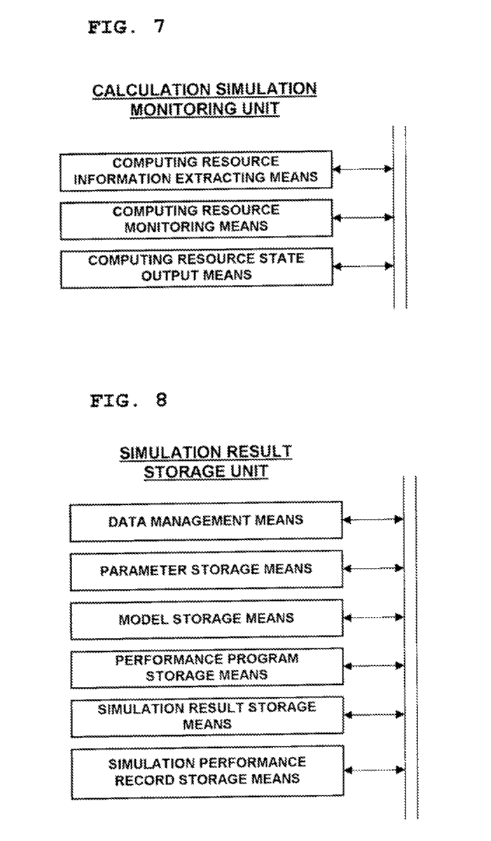

FIG. 7 is a diagram showing the configuration of the calculation simulation monitoring unit of the calculation simulation system in accordance with the exemplary embodiment of the present invention. As shown in FIG. 7, the calculation simulation monitoring unit comprises a computing resource information extracting means, a computing resource monitoring means, and a computing resource state output means.

In more detail, the computing resource information extracting means extracts computing resource information stored by the computing resource setting unit and recognizes the computing resources to be monitored.

The computing resource monitoring means monitors the state of the computing resources and the state of the simulation in progress.

The computing resource state output means outputs information recognized by the computing resource monitoring means.

The simulation result storage means is a component for storing the simulation conditions, simulation results, and performance records.

FIG. 8 is a diagram showing the configuration of the simulation result storage unit of the calculation simulation system in accordance with the exemplary embodiment of the present invention. As shown in FIG. 8, the simulation result storage means comprises a data management means, a parameter storage means, a model storage means, a performance program storage means, a simulation result storage means, and a simulation performance record storage means.

In more detail, the data management means provides a management means for all data managed by the simulation result storage unit.

The parameter storage means stores an input parameter utilized in the simulation as one of the simulation conditions.

The model storage means stores a model to be performed in the simulation.

The performance program storage means stores a program that performs the simulation, which includes a simulation code and a commercially available program.

The simulation result storage means stores the results of the simulation performed by the calculation simulation performing unit.

The simulation performance record storage means stores information related to the simulation performed by the calculation simulation performing unit, such as the simulation conditions, computing resources used, performance time, and information of a performance requestor.

The certificate management unit is a component for managing a certificate required for authentication for use of the computing resources.

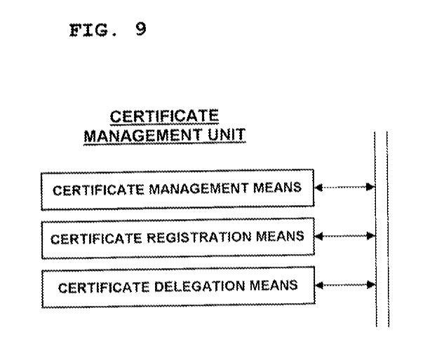

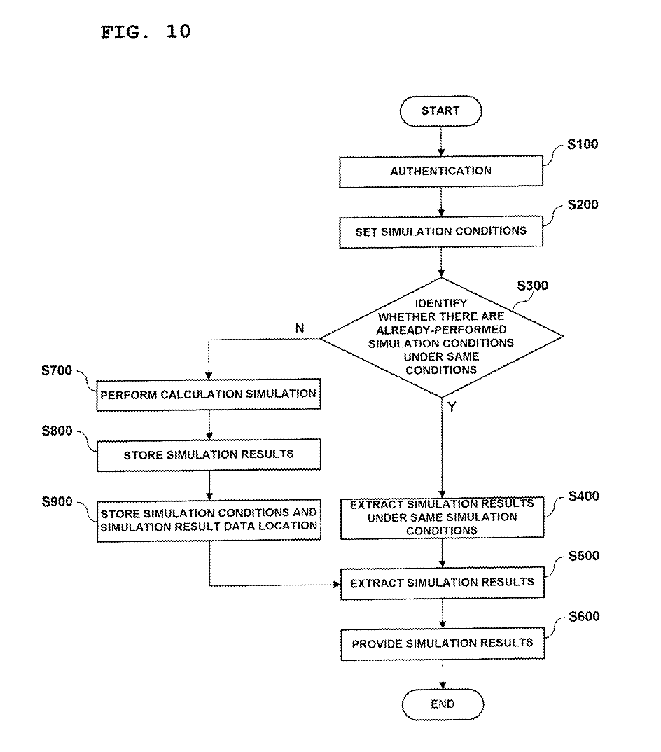

FIG. 9 is a diagram showing the configuration of the certificate management unit of the calculation simulation system in accordance with the exemplary embodiment of the present invention. As shown in FIG. 9, the certificate management unit comprises a certificate management means, a certificate registration means, and a certificate delegation means.

In more detail, the certificate management means manages certificates managed by the certificate management unit.

The certificate registration means registers a certificate of the user.

The certificate delegation means generates a proxy certificate for submitting the work to the computing resources on behalf of the user.

FIG. 10 is a flowchart showing a calculation simulation method in accordance with another exemplary embodiment of the present invention performed by the calculation simulation system of the present invention. As shown in FIG. 10, the calculation simulation method performed by the calculation simulation system is as follows.

First, the certificate management unit delegated by the user to utilize the computing resources may perform authentication on the computing resources (S100).

Next, the user may set the simulation conditions in the simulation condition setting unit using the user terminal (S200).

Then, the simulation function performing unit may retrieve the already-performed simulation conditions which are the same as the current simulation conditions and stored in the simulation result storage unit (S300).

As a result, if there are the already-performed simulation conditions which are the same as the current simulation conditions, the location of the simulation result data under the same simulation conditions may be retrieved (S400) to extract the storage location of the simulation result data (S500), and the simulation results may be provided (S600).

Meanwhile, if there are no already-performed simulation conditions which are the same as the current simulation conditions, the calculation simulation performing unit may perform the calculation simulation under the simulation conditions using the computing resources (S700).

Then, the simulation results may be stored in the simulation result storage unit (S800), and the simulation conditions, the performance record, and the location of the simulation result data may be stored (S900).

Subsequently, the storage location of the simulation result data may be retrieved and extracted in the above manner (S500), and the simulation results may be provided (S600).

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A calculation simulation system which performs a calculation simulation using computing resources, the calculation simulation system comprising:
a simulation condition setting unit that sets simulation conditions based on input from a user;
a calculation simulation performing unit that performs the calculation simulation;
a simulation result storage unit that stores already-performed simulation conditions, simulation results, and performance records; and
a simulation function performing unit that provides the already-performed simulation results, if the simulation conditions input by the user are the same as the already-performed simulation conditions;
wherein the calculation simulation performing unit performs calculation simulation using the computing resources under the simulation conditions input by the user, if the simulation conditions input by the user are different from the already-performed simulation conditions.

2. (canceled)

3. The calculation simulation system of claim 1, wherein the simulation result storage units stores results of the calculation simulation performed by the calculation simulation performing unit under the simulation conditions input by the user.

4. The calculation simulation system of claim 1, wherein the simulation conditions comprise parameters, simulation models, and simulation program-related information.

5. The calculation simulation system of claim 1, wherein the performance records comprise simulation performance date and time, simulation run time, simulation resources used, and data location of simulation results.

6. The calculation simulation system of claim 1, wherein the simulation result storage unit stores the simulation conditions.

7. The calculation simulation system of claim 1, wherein the simulation function performing unit comprises:
a performance record extracting means that extracts the performance records of the already-performed simulation stored in the simulation result storage unit;
a simulation condition comparing means that compares whether the simulation conditions input by the user are the same as the simulation conditions included in the performance records; and
a simulation result extracting means that provides the simulation results stored in the simulation result storage unit, if the simulation conditions input by the user are the same as the simulation conditions extracted.

8. The calculation simulation system of claim 1, wherein the calculation simulation performing unit extracts the simulation conditions from the simulation result storage unit.

9. The calculation simulation system of claim 1, wherein the calculation simulation performing unit generates a work specification including the simulation conditions and a simulation performance program.

10. The calculation simulation system of claim 1, wherein the calculation simulation performing unit stores the simulation results performed on the computing resources in the simulation result storage unit.

11. The calculation simulation system of claim 1, wherein the calculation simulation performing unit stores the simulation conditions, the simulation results, and the performance records in the simulation result storage unit.

12. The calculation simulation system of claim 1, further comprising a computing resource setting unit for setting the computing resources on which the simulation is performed.

13. The calculation simulation system of claim 1, further comprising a simulation monitoring unit for monitoring the state of the simulation performed on the computing resources.

14. The calculation simulation system of claim 1, further comprising a certificate management unit for managing a certificate required for authentication for use of the computing resources.

15. A calculation simulation method which performs a calculation simulation using computing resources, the calculation simulation method comprising:
setting simulation conditions based on input from a user;
retrieving already-performed simulation conditions which are the same as the simulation conditions; and
providing the already-performed simulation results if there are the already-performed simulation conditions which are the same as the simulation conditions;
wherein if there are no already-performed simulation conditions which arc the same as the simulation conditions, further comprising, between the retrieving and the providing of the simulation results, generating the simulation results based on the input from the user by performing calculation simulation under the simulation conditions using the computing resources, and providing the simulation results.

16. The calculation simulation method of claim 15, wherein the providing of the simulation results comprises:
retrieving and extracting a data storage location of the simulation results; and
providing the simulation results.

17. (canceled)

18. The calculation simulation method of claim 15, further comprising, after providing the simulation results, storing the simulation results.

19. The calculation simulation method of claim 18, wherein the storing of the simulation results further comprises storing the simulation conditions input by the user and the data storage location of the simulation results.

20. The calculation simulation method of claim 15, further comprising, before setting the simulation conditions, authenticating use of the computing resources.
